(19) United States
(12) Patent Application Publication
(10) Pub. No.: US 2007/0126662 A1
(43) Pub. Date: Jun. 7, 2007

(54) Plasma display apparatus

(75) Inventor: Jeong Pil Choi, Suwon-si (KR)

Correspondence Address: KED & ASSOCIATES, LLP, P.O. Box 221200, Chantilly, VA, 20153-1200, US

(73) Assignee: LG Electronics Inc.

(21) Appl. No.: 11/607,862

(22) Filed: Dec. 4, 2006

(30) Foreign Application Priority Data
Dec. 5, 2005 (KR) 10-2005-0117693

(51) Int. Cl. G09G 3/28

(52) U.S. Cl. 345/68

(57) ABSTRACT

A plasma display apparatus is disclosed. The plasma display apparatus a first energy recovery circuit and a second energy recovery circuit. The first energy recovery circuit forms a first energy supply path for supplying an energy to a scan electrode and a first energy recovery path for recovering an energy from the scan electrode. The second energy recovery circuit forms a second energy supply path for supplying an energy to a sustain electrode and a second energy recovery path for recovering an energy from the sustain electrode. Inductance of an inductor positioned on the first energy supply path is less than inductance of an inductor positioned in the first energy recovery path. Inductance of an inductor positioned on the second energy supply path is less than inductance of an inductor positioned on the second energy recovery path.

This Nonprovisional application claims priority under 35 U.S.C. § 119(a) on Patent Application No. 10-2005-0117693 filed in Korea on Dec. 5, 2005 the entire contents of which are hereby incorporated by reference.

### BACKGROUND

1. Field

This document relates to a display apparatus, and more particularly, to a plasma display apparatus.

2. Description of the Related Art

Out of display apparatuses, a plasma display apparatus comprises a plasma display panel and a driver for driving the plasma display panel.

The plasma display panel has the structure in which barrier ribs formed between a front panel and a rear panel forms unit discharge cell or discharge cells. Each discharge cell is filled with an inert gas containing a main discharge gas such as neon (Ne), helium (He) and a mixture of Ne and He, and a small amount of xenon (Xe).

The plurality of discharge cells form one pixel. For example, a red (R) discharge cell, a green (G) discharge cell, and a blue (B) discharge cell form one pixel.

When the plasma display panel is discharged by a high frequency voltage, the inert gas generates vacuum ultraviolet rays, which thereby cause phosphors formed between the barrier ribs to emit light, thus displaying an image. Since the plasma display panel can be manufactured to be thin and light, it has attracted attention as a next generation display device.

The related art plasma display panel requires a high voltage of several hundreds of volts in the generation of an address discharge and a sustain discharge. Accordingly, it is necessary to reduce a driving voltage. For this, a driving circuit of the plasma display panel generally adopts an energy recovery circuit.

The energy recovery circuit recovers charges accumulated on scan electrode lines and sustain electrode lines and charges accumulated on address electrode lines, thereby reusing the recovered charges in a next discharge.

However, since the related art energy recovery circuit uses the same inductor in an energy recovery operation and an energy supply operation of the related art energy recovery circuit, the discharge efficiency is reduced.

In one aspect, a plasma display apparatus comprises a plasma display panel including a scan electrode and a sustain electrode, a first energy recovery circuit that forms a first energy supply path for supplying an energy to the scan electrode and a first energy recovery path for recovering an energy from the scan electrode, and a second energy recovery circuit that forms a second energy supply path for supplying an energy to the sustain electrode and a second energy recovery path for recovering an energy from the sustain electrode, wherein inductance of an inductor positioned on the first energy supply path is less than inductance of an inductor positioned in the first energy recovery path, and inductance of an inductor positioned on the second energy supply path is less than inductance of an inductor positioned on the second energy recovery path, and a sum of inductances of a plurality of inductors included in the first energy recovery circuit is different from a sum of inductances of a plurality of inductors included in the second energy recovery circuit.

In another aspect, a plasma display apparatus comprises a plasma display panel including a scan electrode and a sustain electrode, a first energy recovery circuit that forms a first energy supply path for supplying an energy to the scan electrode and a first energy recovery path for recovering an energy from the scan electrode, a first inductor being positioned on the first energy supply path, and a second inductor being positioned on the first energy recovery path, and a second energy recovery circuit that forms a second energy supply path for supplying an energy to the sustain electrode and a second energy recovery path for recovering an energy from the sustain electrode, a third inductor being positioned on the second energy supply path, and a fourth inductor being positioned on the second energy recovery path, wherein inductance of the first inductor is less than inductance of the second inductor, and inductance of the third inductor is less than inductance of the fourth inductor, and a sum of the inductances of the first and second inductors is different from a sum of the inductances of the third and fourth inductors.

In still another aspect, a plasma display apparatus comprises a plasma display panel including a scan electrode and a sustain electrode, a first energy recovery circuit that forms a first energy supply path for supplying an energy to the scan electrode and a first energy recovery path for recovering an energy from the scan electrode, a first inductor being positioned on the first energy supply path, and the first inductor and a second inductor being positioned on the first energy recovery path, and a second energy recovery circuit that forms a second energy supply path for supplying an energy to the sustain electrode and a second energy recovery path for recovering an energy from the sustain electrode, a third inductor being positioned on the second energy supply path, and the third inductor and a fourth inductor being positioned on the second energy recovery path, wherein a sum of inductances of the first and second inductors is different from a sum of inductances of the third and fourth inductors.

### BRIEF DESCRIPTION OF THE DRAWINGS

The accompany drawings, which are included to provide a further understanding of the invention and are incorporated on and constitute a part of this specification, illustrate embodiments of the invention and together with the description serve to explain the principles of the invention.

FIG. 1 is an exploded perspective view of the structure of a plasma display panel of a plasma display apparatus according to embodiments;

FIG. 2 is a plane view of the disposition structure of each of an electrode line and a discharge cell in the plasma display panel of FIG. 1;

FIG. 3 illustrates an energy recovery circuit of a plasma display apparatus according to a first embodiment;

FIG. 4 illustrates a driving waveform generated by the energy recovery circuit of FIG. 3;

FIG. 5 illustrates an energy recovery circuit of a plasma display apparatus according to a second embodiment; and

FIG. 6 illustrates an energy recovery circuit of a plasma display apparatus according to a third embodiment.

### DETAILED DESCRIPTION OF PREFERRED EMBODIMENTS

Reference will now be made in detail embodiments of the invention examples of which are illustrated in the accompanying drawings.

A plasma display apparatus comprises a plasma display panel including a scan electrode and a sustain electrode, a first energy recovery circuit that forms a first energy supply path for supplying an energy to the scan electrode and a first energy recovery path for recovering an energy from the scan electrode, and a second energy recovery circuit that forms a second energy supply path for supplying an energy to the sustain electrode and a second energy recovery path for recovering an energy from the sustain electrode, wherein inductance of an inductor positioned on the first energy supply path is less than inductance of an inductor positioned in the first energy recovery path, and inductance of an inductor positioned on the second energy supply path is less than inductance of an inductor positioned on the second energy recovery path, and a sum of inductances of a plurality of inductors included in the first energy recovery circuit is different from a sum of inductances of a plurality of inductors included in the second energy recovery circuit.

The sum of the inductances of the plurality of inductors included in the first energy recovery circuit may be less than the sum of the inductances of the plurality of inductors included in the second energy recovery circuit.

The inductance of the inductor positioned on the first energy supply path may be less than the inductance of the inductor positioned on the second energy supply path.

The inductance of the inductor positioned on the first energy recovery path may be less than the inductance of the inductor positioned on the second energy recovery path.

The number of inductors positioned on the first energy recovery path may be equal to one or more, and the number of inductors positioned on the second energy recovery path may be equal to one or more.

Time required to supply the energy to the scan electrode may be shorter than time required to recover the energy from the scan electrode, and time required to supply the energy to the sustain electrode may be shorter than time required to recover the energy from the sustain electrode.

A plasma display apparatus comprises a plasma display panel including a scan electrode and a sustain electrode, a first energy recovery circuit that forms a first energy supply path for supplying an energy to the scan electrode and a first energy recovery path for recovering an energy from the scan electrode, a first inductor being positioned on the first energy supply path, and a second inductor being positioned on the first energy recovery path, and a second energy recovery circuit that forms a second energy supply path for supplying an energy to the sustain electrode and a second energy recovery path for recovering an energy from the sustain electrode, a third inductor being positioned on the second energy supply path, and a fourth inductor being positioned on the second energy recovery path, wherein inductance of the first inductor is less than inductance of the second inductor, and inductance of the third inductor is less than inductance of the fourth inductor, and a sum of the inductances of the first and second inductors is different from a sum of the inductances of the third and fourth inductors.

The sum of the inductances of the first and second inductors may be less than the sum of the inductances of the third and fourth inductors.

The inductance of the first inductor may be less than the inductance of the third inductor.

The inductance of the second inductor may be less than the inductance of the fourth inductor.

The first energy recovery circuit may include a first source capacitor charged to the energy recovered from the scan electrode, a first energy supply controller connected between the first source capacitor and the first inductor, and a first energy recovery controller connected between the first source capacitor and the second inductor.

The first energy supply path may pass through the first source capacitor, the first energy supply controller, and the first inductor, and the first energy recovery path may pass through the second inductor, the first energy recovery controller, and the first source capacitor.

The second energy recovery circuit may include a second source capacitor charged to the energy recovered from the sustain electrode, a second energy supply controller connected between the second source capacitor and the third inductor, and a second energy recovery controller connected between the second source capacitor and the fourth inductor.

The second energy supply path may pass through the second source capacitor, the second energy supply controller, and the third inductor, and the second energy recovery path may pass through the fourth inductor, the second energy recovery controller, and the second source capacitor.

Time required to supply the energy to the scan electrode may be shorter than time required to recover the energy from the scan electrode, and time required to supply the energy to the sustain electrode may be shorter than time required to recover the energy from the sustain electrode.

A plasma display apparatus comprises a plasma display panel including a scan electrode and a sustain electrode, a first energy recovery circuit that forms a first energy supply path for supplying an energy to the scan electrode and a first energy recovery path for recovering an energy from the scan electrode, a first inductor being positioned on the first energy supply path, and the first inductor and a second inductor being positioned on the first energy recovery path, and a second energy recovery circuit that forms a second energy supply path for supplying an energy to the sustain electrode and a second energy recovery path for recovering an energy from the sustain electrode, a third inductor being positioned on the second energy supply path, and the third inductor and a fourth inductor being positioned on the second energy recovery path, wherein a sum of inductances of the first and second inductors is different from a sum of inductances of the third and fourth inductors.

The sum of the inductances of the first and second inductors may be less than the sum of the inductances of the third and fourth inductors.

The inductance of the first inductor may be less than the inductance of the third inductor.

The inductance of the second inductor may be less than the inductance of the fourth inductor.

The first energy recovery circuit may include a first source capacitor charged to the energy recovered from the scan electrode, a first energy supply controller connected between the first source capacitor and a common terminal of the first and second inductors, and a first energy recovery controller connected between the first source capacitor and the second inductor.

The second energy recovery circuit may include a second source capacitor charged to the energy recovered from the sustain electrode, a second energy supply controller connected between the second source capacitor and a common terminal of the third and fourth inductors, and a second energy recovery controller connected between the second source capacitor and the fourth inductor.

The first energy supply path may pass through the first source capacitor, the first energy supply controller, and the first inductor, and the first energy recovery path may pass through the first inductor, the second inductor, the first energy recovery controller, and the first source capacitor. The second energy supply path may pass through the second source capacitor, the second energy supply controller, and the third inductor, and the second energy recovery path may pass through the third inductor, the fourth inductor, the second energy recovery controller, and the second source capacitor.

Time required to supply the energy to the scan electrode may be shorter than time required to recover the energy from the scan electrode, and time required to supply the energy to the sustain electrode may be shorter than time required to recover the energy from the sustain electrode.

Hereinafter, exemplary embodiments of the present invention will be described in detail with reference to the attached drawings.

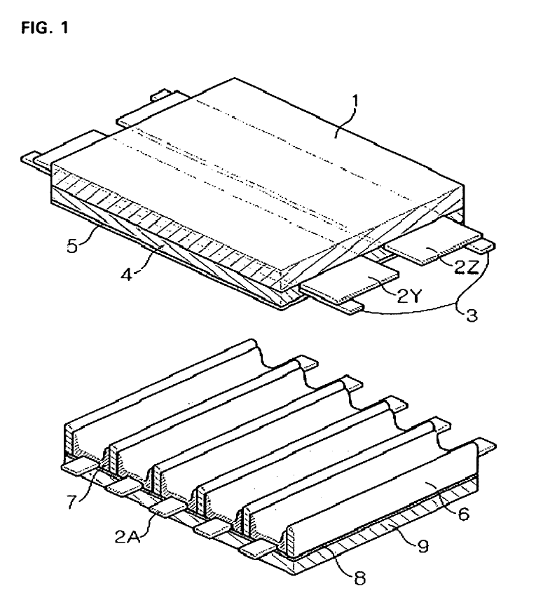

FIG. 1 is an exploded perspective view of the structure of a plasma display panel of a plasma display apparatus according to embodiments.

As illustrated in FIG. 1, each discharge cell includes a scan electrode 2Y and a sustain electrode 2Z formed on a front substrate 1, and an address electrode 2A formed on a rear substrate 9.

The scan electrode 2Y and the sustain electrode 2Z are generally made of an indium-tin-oxide (ITO) material. A bus electrode 3 made of a metal such as Cr is formed on the scan electrode 2Y and the sustain electrode 2Z to reduce a voltage drop caused by a high resistance of the ITO material.

On the front substrate 1 on which the scan electrode 2Y and the sustain electrode 2Z are formed in parallel, an upper dielectric layer 4 and a protective layer 5 are stacked. The protective layer 5 is generally made of MgO to prevent a damage to the upper dielectric layer 4 caused by sputtering generated when generating a plasma discharge and to increase a secondary electron emission coefficient.

On the rear substrate 9 on which the address electrode 2A is formed, a lower dielectric layer 8 and barrier ribs 6 are formed. A phosphor 7 is coated on the surface of the lower dielectric layer 8 and the surfaces of the barrier ribs 6. The address electrode 2A is formed in perpendicular to the scan electrode 2Y and the sustain electrode 2Z. The barrier ribs 6 are formed in parallel to the address electrode 2A. The barrier ribs 6 prevent ultraviolet rays and visible light generated by performing the plasma discharge from leaking into adjacent discharge cells.

Ultraviolet rays generated in the plasma discharge excite the phosphor 7 such that one of red (R) visible light, green (G) visible light or blue (B) visible light is generated. Each of a plurality of discharge cells defined by the front substrate 1, the rear substrate 9, and the barrier ribs 6 is filled with a mixture gas of Ne and Xe and a penning gas for a gas discharge, and the like.

Discharge cells to be discharged are selected from the plurality of discharge cells having the above-described structure by performing an opposite discharge generated between the address electrode 2A and the scan electrode 2Y. Then, a discharge generated in the selected discharge cells is maintained by a surface discharge generated between the scan electrode 2Y and the sustain electrode 2Z.

Ultraviolet rays generated by performing a sustain discharge excite the phosphor 7 inside the discharge cells such that visible light is emitted from the discharge cells to the outside. As a result, the discharge cells control a duration of a discharge maintenance period such that a gray level is achieved. An image is displayed on the plasma display panel having the discharge cells, which are arranged in a matrix pattern.

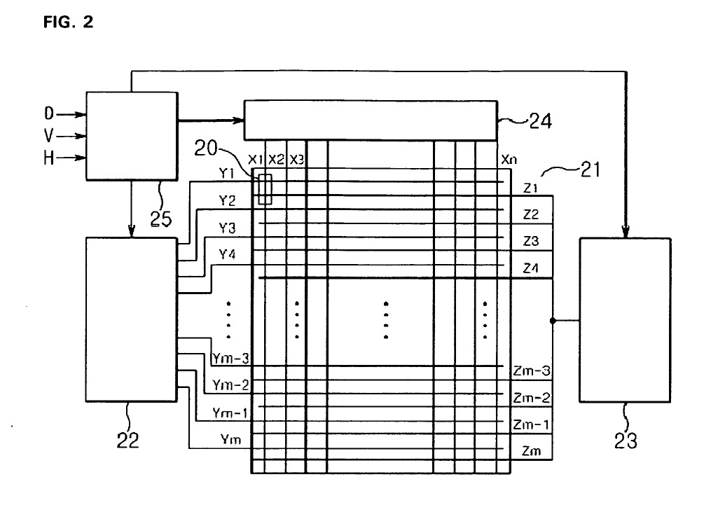

FIG. 2 is a plane view of the disposition structure of each of an electrode line and a discharge cell in the plasma display panel of FIG. 1.

As illustrated in FIG. 2, the plasma display apparatus according to the embodiments includes a plasma display panel 21, a scan driving circuit 22, a sustain driving circuit 23, an address driving circuit 24, and a control circuit 25. In the plasma display panel 21, m×n discharge cells 20 are arranged in a matrix pattern in which scan electrode lines Y1 to Ym, sustain electrode lines Z1 to Zm, and address electrode lines X1 to Xn are connected to one another inside each of the m×n discharge cells 20. The scan driving circuit 22 drives the scan electrode lines Y1 to Ym. The sustain driving circuit 23 drives the sustain electrode lines Z1 to Zm. The address driving circuit 24 drives the address electrode lines X1 to Xn. The control circuit 25 supplies each of the driving circuits 22, 23 and 24 a driving signal based on display data (D), a horizontal synchronization signal (H), a vertical synchronization signal (V), a clock signal, and the like, which are input from the outside.

The scan driving circuit 22 sequentially supplies a reset pulse, a scan pulse, and a sustain pulse to the scan electrode lines Y1 to Ym such that the m×n discharge cells 20 are sequentially scanned for each scan electrode line and a discharge in each of the m×n discharge cells 20 is maintained. The reset pulse uniforms initialization states of all the discharge cells, the scan pulse (or address pulse) selects cells to be discharged, and the sustain pulse represents a gray level in accordance with the number of discharges.

The sustain driving circuit 23 supplies a sustain pulse to all the sustain electrode lines Z1 to Zm, thereby generating a sustain discharge in the discharge cells selected by supplying the scan pulse. The scan driving circuit 22 and the sustain driving circuit 23 alternately supply the sustain pulse.

The address driving circuit 24 supplies an address pulse synchronized with the scan pulse supplied to the scan electrode lines Y1 to Ym to the address electrode lines X1 to Xn, thereby selecting cells to be discharged.

The plasma display panel thus driven requires a high voltage of several hundreds of volts in generating an address discharge and a sustain discharge.

Accordingly, it is necessary to reduce a driving voltage. For this, each of the scan driving circuit 22 and the sustain driving circuit 23 generally adopts an energy recovery circuit. Further, the address driving circuit 24 generally adopts an energy recovery circuit.

The energy recovery circuit recovers charges accumulated on the scan electrode lines Y1 to Ym and the sustain electrode lines Z1 to Zm and charges accumulated on the address electrode lines X1 to Xn, thereby reusing the recovered charges in a next discharge. An operation of the energy recovery circuit will be described in detail below.

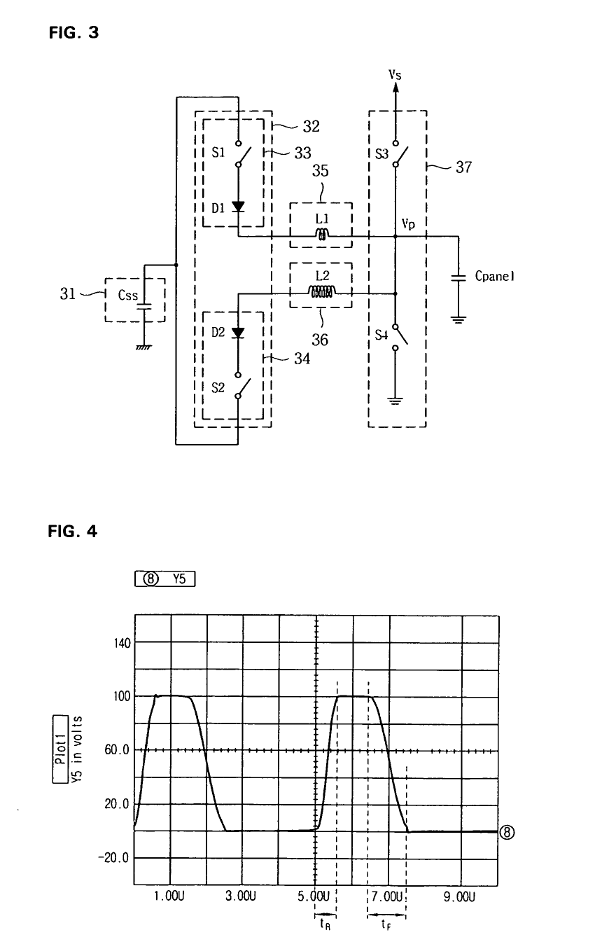

FIG. 3 illustrates an energy recovery circuit of a plasma display apparatus according to a first embodiment.

As illustrated in FIG. 3, the energy recovery circuit of the plasma display apparatus according to the first embodiment includes a source capacitor (Css) 31, an energy recovery/supply controller 32, a first inductor 35, a second inductor 36, and a sustain pulse supply controller 37.

One terminal of the source capacitor (Css) 31 is connected to a ground level voltage V_{GND}, and the other terminal is commonly connected to one terminal of an energy supply controller 33 and one terminal of an energy recovery controller 34 such that the source capacitor (Css) 31 is charged to energy recovered from a plasma display panel Cpanel.

The energy recovery/supply controller 32 includes the energy supply controller 33 and the energy recovery controller 34.

The energy supply controller 33 includes a first switch S1 and a first diode D1. The first switch S1 is turned on to perform an energy supply operation such that the energy supply controller 33 is used to form an energy supply path.

The energy recovery controller 34 includes a second switch S2 and a second diode D2. The second switch S2 is turned on to perform an energy recovery operation such that the energy recovery controller 34 is used to form an energy recovery path.

The first inductor (L1) 35 is connected between the energy supply controller 33 and the plasma display panel Cpanel. The second inductor (L2) 36 is connected between the energy recovery controller 34 and the plasma display panel Cpanel.

The sustain pulse supply controller 37 includes a third switch S3 and a fourth switch S4. The third switch S3 and the fourth switch S4 are connected to a sustain voltage source (not illustrated) and a ground level voltage source (not illustrated), respectively. The third switch S3 and the fourth switch S4 are turned on to supply a sustain voltage Vs and a ground level voltage V_{GND} to the plasma display panel Cpanel.

An operation of the energy recovery circuit according to the first embodiment mainly includes four stages.

It is assumed that a voltage Vp of the plasma display panel Cpanel is equal to 0V, and a charging voltage to the source capacitor Css is equal to Vs/2.

In a first stage, the first switch S1 is turned on and the second, third, and fourth switches S2, S3 and S4 are turned off. As a result, the energy supply path passing through the source capacitor Css, the first switch S1, the first diode D1, and the first inductor L1 is formed. Although the switches are simply illustrated in the form of a switch in the attached drawings, the switches illustrated in the attached drawings indicate a transistor including a body diode, unless otherwise defined.

Since the first inductor L1 and the plasma display panel Cpanel form a serial resonance circuit and the charging voltage to the source capacitor Css is equal to Vs/2, the voltage Vp of the plasma display panel Cpanel rises to the sustain voltage Vs equal to two times the charging voltage Vs/2 of the source capacitor Css.

The energy recovery circuit according to the first embodiment uses the first inductor L1 to supply the charging voltage of the source capacitor Css to the plasma display panel Cpanel.

In a second stage, the first switch S1 and the third switch S3 are turned on and the second switch S2 and the fourth switch S4 are turned off.

As a result, the voltage Vp of the plasma display panel Cpanel is equal to the sustain voltage Vs. The moment the first stage is complete (i.e., the moment the voltage Vp of the plasma display panel Cpanel is equal to the sustain voltage Vs using LC resonance), the sustain voltage source supplies the sustain voltage Vs to the plasma display panel Cpanel and then the voltage Vp of the plasma display panel Cpanel is maintained at the sustain voltage Vs for a predetermined period of time.

In a third stage, the second switch S2 is turned on, and the first, third and fourth switches S1, S3 and S4 are turned off. As a result, the source capacitor Css is charged to the energy stored in the plasma display panel Cpanel, and the voltage Vp of the plasma display panel Cpanel falls.

In the third stage, the energy recovery path passing through the plasma display panel Cpanel, the second inductor L2, the second diode D2, the second switch S2, and the source capacitor Css is formed.

The energy recovery circuit according to the first embodiment uses the second inductor L2 to recover the energy from the plasma display panel Cpanel. In this case, inductance of the second inductor L2 used to recover the energy from the plasma display panel Cpanel is more than inductance of the first inductor L1 used to supply the energy to the plasma display panel Cpanel.

As above, when the inductance of the second inductor L2 used to recover the energy from the plasma display panel Cpanel is more than the inductance of the first inductor L1 used to supply the energy to the plasma display panel Cpanel, the energy recovery efficiency further increases.

Since the inductance in the energy recovery operation is more than the inductance in the energy supply operation, time required to raise the voltage Vp of the plasma display panel Cpanel to the sustain voltage Vs in the energy supply operation is reduced such that a strong discharge occurs. Further, the inductance in the energy recovery operation increases such that the energy recovery efficiency increases. Of course, as a difference between the inductance of the second inductor L2 and the inductance of the first inductor L1 increases, the energy recovery efficiency further increases.

In a fourth stage, the second switch S2 and the fourth switch S4 are turned on and the first switch S1 and the third switch S3 are turned off. As a result, the voltage Vp of the plasma display panel Cpanel is equal to the ground level voltage V_{GND}.

The moment the third stage is complete (i.e., the moment the voltage Vp of the plasma display panel Cpanel is equal to the ground level voltage V_{GND} using LC resonance), the ground level voltage source supplies the ground level voltage V_{GND} to the plasma display panel Cpanel and then the voltage Vp of the plasma display panel Cpanel is maintained at the ground level voltage V_{GND} for a predetermined period of time.

FIG. 4 illustrates a driving waveform generated by the energy recovery circuit of FIG. 3.

As illustrated in FIG. 4, time required to supply the energy to the plasma display panel Cpanel, i.e., rising time tR is short, and time required to recover the energy from the plasma display panel Cpanel, i.e., falling time tF is two times the rising time tR. In other words, since the inductance of the second inductor L2 used to recover the energy from the plasma display panel Cpanel is more than the inductance of the first inductor L1 used to supply the energy to the plasma display panel Cpanel, the strong discharge occurs and the energy recovery efficiency increases.

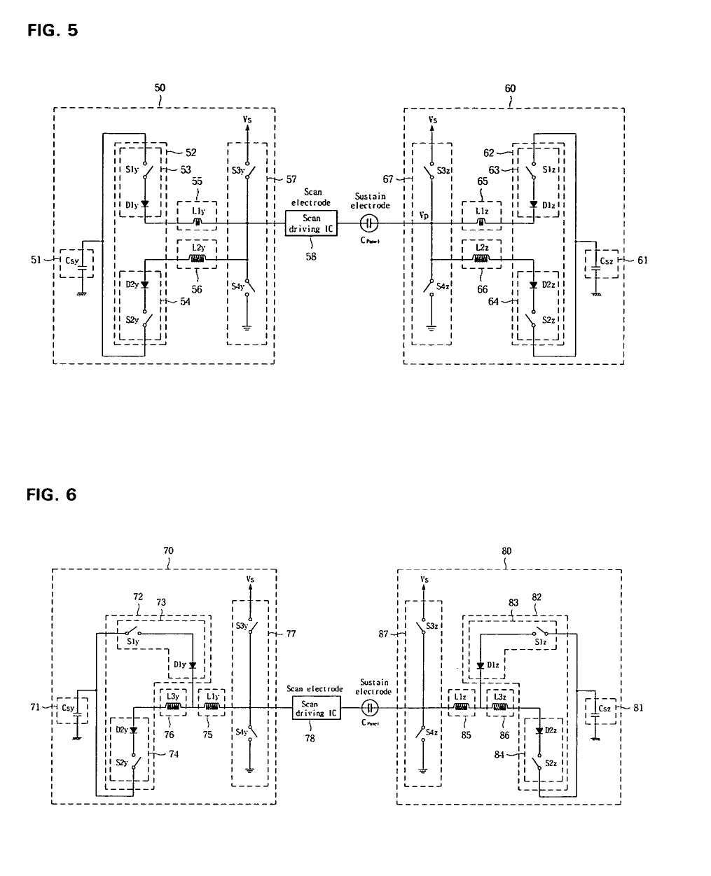

FIG. 5 illustrates an energy recovery circuit of a plasma display apparatus according to a second embodiment.

In a related plasma display apparatus, an energy recovery circuit is connected to each of a scan electrode and a sustain electrode of a plasma display panel, and a scan driving integrated circuit (IC) is installed between the scan electrode and the energy recovery circuit for the scan electrode. Inductances of a plurality of inductors included in the energy recovery circuit for the scan electrode is equal to inductances of a plurality of inductors included in the energy recovery circuit for the sustain electrode.

An output of the energy recovery circuit for the sustain electrode is directly applied to the sustain electrode. On the other hand, an output of the energy recovery circuit for the scan electrode is applied to the scan electrode through a switching element of the scan driving IC installed between the scan electrode and the energy recovery circuit for the scan electrode. Accordingly, a driving performance of the energy recovery circuit for the scan electrode is different from a driving performance of the energy recovery circuit for the sustain electrode due to self-inductance of the switching element of the scan driving IC.

Accordingly, the energy recovery circuit of the plasma display apparatus according to the second embodiment compensates a difference between driving performances of an energy recovery circuit for the scan electrode and an energy recovery circuit for the sustain electrode, which may be caused by a difference between the configurations of the energy recovery circuit for the scan electrode and the energy recovery circuit for the sustain electrode. The difference between driving performances is compensated by controlling inductances of a plurality of inductors included in the energy recovery circuit for the scan electrode and inductances of a plurality of inductors included in the energy recovery circuit for the sustain electrode.

As a factor causing the difference between the driving performance of the energy recovery circuit for the scan electrode (i.e., a first energy recovery circuit 50) and the driving performance of the energy recovery circuit for the sustain electrode (i.e., a second energy recovery circuit 60), there is a scan driving IC 58 or an additional circuit for generating a reset signal supplied to the scan electrode during a reset period.

Since the number of circuits connected to the scan electrode is more than the number of circuits connected to the sustain electrode, inductance of each of two inductors (i.e., first and second inductors) L1y and L2y of the first energy recovery circuit 50 has to be less than inductance of each of two inductors (i.e., third and fourth inductors) L1z and L2z of the second energy recovery circuit 60. As a result, the driving performances of the first energy recovery circuit 50 and the second energy recovery circuit 60 are the same.

In other words, the first and third inductors L1y and L1z are associated with an energy supply operation for supplying the energy to the plasma display panel Cpanel, and the second and fourth inductors L2y and L2z are associated with an energy recovery operation for recovering the energy from the plasma display panel Cpanel. In this case, inductances of the inductors satisfy the following relationships: L1y<L2y, L1z<L2z, L1y<L1z, and L2y<L2z. Inductance of each inductor may be determined by a measurement, an experiment, and a simulation.

On the contrary, inductances of the two inductors L1z and L2z of the second energy recovery circuit 60 may be less than inductances of the two inductors L1y and L2y of the first energy recovery circuit 50. This reason is that there may be a difference between driving circuits of each maker. Inductance of each inductor may be determined by an experiment and a simulation so that inductances of the inductors satisfy the following relationships: L1y<L2y, L1z<L2z, L1z<L1y, and L2z<L2y.

As above, when the plasma display apparatus according to the second embodiment uses the different inductors in the energy supply operation and the energy recovery operation, the inductances of the inductors satisfy the following relationships: L1y<L2y, L1z<L2z, L1y*L1z, and L2y*L2z.

Since the circuit configuration and the operation of each of the first and second energy recovery circuits 50 and 60 according to the second embodiment are the same as the circuit configuration and the operation of the energy recovery circuit of FIG. 3 according to the first embodiment, a description thereof is omitted.

As above, the inductances of the inductors of the first and second energy recovery circuits 50 and 60 satisfy the following relationships: L1y<L1z and L2y<L2z so that the driving performances of the first and second energy recovery circuits 50 and 60 are the same. The difference between the driving performances of the first and second energy recovery circuits 50 and 60 is caused by the scan driving IC 58 installed between the scan electrode of the plasma display panel Cpanel and the first energy recovery circuit 50.

The energy supply and recovery operations between the second energy recovery circuit 60 and the sustain electrode are directly performed without an additional circuit therebetween. On the other hand, the energy supply and recovery operations between the first energy recovery circuit 50 and the scan electrode are performed through a switching element (not illustrated) of the scan driving IC 58. In this case, since the switching element of the scan driving IC 58 has self-inductance (hereinafter, referred to as “Ls”), the inductances of the inductors of the first and second energy recovery circuits 50 and 60 have to satisfy the following relationships: L1y<L1z and L2y<L2z to identify the driving performances of the first and second energy recovery circuits 50 and 60.

In this case, the inductances of the inductors of the first and second energy recovery circuits 50 and 60 may be determined by a measurement, an experiment, and a simulation, and the like. It is preferable that the inductances of the inductors satisfy the following relationships: L1z=L1y+Ls and L2z=L1z+Ls.

FIG. 6 illustrates an energy recovery circuit of a plasma display apparatus according to a third embodiment.

As illustrated in FIG. 6, the plasma display apparatus according to the third embodiment includes a first energy recovery circuit 70, a second energy recovery circuit 80, and a scan driving IC 78.

Since a configuration and an operation of the first energy recovery circuit 70 are the same as a configuration and an operation of the second energy recovery circuit 80, the first energy recovery circuit 70 will be described below and a description of the second energy recovery circuit 80 is omitted.

The first energy recovery circuit 70 of the plasma display apparatus according to the third embodiment includes a first source capacitor (Csy) 71, a first energy recovery/supply controller 72, a first inductor (Lly) 75, a second inductor (L3y) 76, and a first sustain pulse supply controller 77.

One terminal of the source capacitor (Csy) 71 is connected to a ground level voltage V_{GND}, and the other terminal is commonly connected to one terminal of a first energy supply controller 73 and one terminal of a first energy recovery controller 74 such that the source capacitor (Csy) 71 is charged to energy recovered from a plasma display panel Cpanel.

The energy recovery/supply controller 72 includes the first energy supply controller 73 and the first energy recovery controller 74.

The first energy supply controller 73 includes a first switch S1y and a first diode D1y. The first switch Sly is turned on to perform an energy supply operation such that the energy supply controller 73 is used to form an energy supply path.

The first energy recovery controller 74 includes a second switch S2y and a second diode D2y. The second switch S2y is turned on to perform an energy recovery operation such that the energy recovery controller 74 is used to form an energy recovery path.

The first inductor (L1y) 75 is connected between the first energy supply controller 73 and the plasma display panel Cpanel. The second inductor (L3y) 76 is connected between a common terminal of the first energy supply controller 73 and the first inductor (L1y) 75 and the first energy recovery controller 74.

The first sustain pulse supply controller 77 includes a third switch S3y and a fourth switch S4y. The third switch S3y and the fourth switch S4y are connected to a sustain voltage source (not illustrated) and a ground level voltage source (not illustrated), respectively. The third switch S3y and the fourth switch S4y are turned on to supply a sustain voltage Vs and a ground level voltage V_{GND} to the plasma display panel Cpanel.

An operation of the first energy recovery circuit according to the third embodiment mainly includes four stages.

It is assumed that a voltage Vp of the plasma display panel Cpanel is equal to 0V, and a charging voltage to the source capacitor Csy is equal to Vs/2.

In a first stage, the first switch S1y is turned on and the second, third, and fourth switches S2y, S3y and S4y are turned off. As a result, the energy supply path passing through the first source capacitor Csy, the first switch S1y, the first diode D1y, and the first inductor Lly is formed. Although the switches are simply illustrated in the form of a switch in the attached drawings, the switches illustrated in the attached drawings indicate a transistor including a body diode, unless otherwise defined.

Since the first inductor L1y and the plasma display panel Cpanel form a serial resonance circuit and the charging voltage to the first source capacitor Csy is equal to Vs/2, the voltage Vp of the plasma display panel Cpanel rises to the sustain voltage Vs equal to two times the charging voltage Vs/2 of the first source capacitor Csy.

The first energy recovery circuit 70 according to the third embodiment uses one inductor, i.e., the first inductor L1y when supplying the charging voltage of the first source capacitor Csy to the plasma display panel Cpanel. Therefore, inductance in the case of supplying the energy to the plasma display panel Cpanel is small such that a strong discharge occurs.

In a second stage, the first switch S1y and the third switch S3y are turned on and the second switch S2y and the fourth switch S4y are turned off.

As a result, the voltage Vp of the plasma display panel Cpanel is equal to the sustain voltage Vs. The moment the first stage is complete (i.e., the moment the voltage Vp of the plasma display panel Cpanel is equal to the sustain voltage Vs using LC resonance), the sustain voltage source supplies the sustain voltage Vs to the plasma display panel Cpanel and then the voltage Vp of the plasma display panel Cpanel is maintained at the sustain voltage Vs for a predetermined period of time.

In a third stage, the second switch S2y is turned on, and the first, third and fourth switches S1y, S3y and S4y are turned off. As a result, the source capacitor Csy is charged to the energy stored in the plasma display panel Cpanel, and the voltage Vp of the plasma display panel Cpanel falls.

In the third stage, the energy recovery path passing through the plasma display panel Cpanel, the first inductor L1y, the second inductor L3y, the second diode D2y, the second switch S2y, and the first source capacitor Csy is formed.

The first energy recovery circuit 70 according to the third embodiment uses the plurality of inductors, i.e., the first inductor Lly and the second inductor L3y when recovering the energy from the plasma display panel Cpanel. Therefore, inductance in the case of recovering the energy from the plasma display panel Cpanel is more than inductance in the case of supplying the energy to the plasma display panel Cpanel, thereby increasing the energy recovery efficiency.

For example, when inductance of the first inductor L1y is equal to inductance of the second inductor L3y, inductance in the energy recovery operation is two times inductance in the energy supply operation. Accordingly, time required to raise the voltage Vp of the plasma display panel Cpanel to the sustain voltage Vs in the energy supply operation is reduced such that the strong discharge occurs. Further, the inductance in the energy recovery operation increases such that the energy recovery efficiency increases. Of course, as a difference between the inductance of the second inductor L3y and the inductance of the first inductor L1y increases, the energy recovery efficiency further increases.

In a fourth stage, the second switch S2y and the fourth switch S4y are turned on and the first switch Sly and the third switch S3y are turned off. As a result, the voltage Vp of the plasma display panel Cpanel is equal to the ground level voltage V_{GND}.

The moment the third stage is complete (i.e., the moment the voltage Vp of the plasma display panel Cpanel is equal to the ground level voltage V_{GND} using LC resonance), the ground level voltage source supplies the ground level voltage V_{GND} to the plasma display panel Cpanel and then the voltage Vp of the plasma display panel Cpanel is maintained at the ground level voltage V_{GND} for a predetermined period of time.

As above, the inductances of the two inductors L1y and L3y of the first energy recovery circuit 70 are less than the inductances of the two inductors L1z and L3z of the second energy recovery circuit 80 so that the driving performances of the first and second energy recovery circuits 70 and 80 are the same.

The difference between the driving performances of the first and second energy recovery circuits 70 and 70 is caused by the scan driving IC 78 installed between the scan electrode of the plasma display panel Cpanel and the first energy recovery circuit 70.

The energy supply and recovery operations between the second energy recovery circuit 80 and the sustain electrode are directly performed without an additional circuit therebetween. On the other hand, the energy supply and recovery operations between the first energy recovery circuit 70 and the scan electrode are performed through a switching element (not illustrated) of the scan driving IC 78. In this case, since the switching element of the scan driving IC 78 has self-inductance (hereinafter, referred to as “Ls”), the inductances of the inductors of the first and second energy recovery circuits 70 and 80 have to satisfy the following relationships: L1y<L1z and L3y<L3z to identify the driving performances of the first and second energy recovery circuits 70 and 80.

The following is a detailed description of the energy supply and recovery operations of each of the first and second energy recovery circuits 70 and 80.

When performing the energy supply operation in the first energy recovery circuit 70, the total inductance in the energy supply operation is equal to L1y+Ls. When performing the energy supply operation in the second energy recovery circuit 80, the total inductance in the energy supply operation is equal to L1z. Accordingly, the inductances of the inductors L1y and L1z satisfy a relationship of L1z=L1y+Ls (L1z>L1y) to identify the driving performances of the energy supply operations in the first and second energy recovery circuits 70 and 80.

On the other hand, when performing the energy recovery operation in the first energy recovery circuit 70, the total inductance in the energy recovery operation is equal to Ls+L1y+L3y. When performing the energy recovery operation in the second energy recovery circuit 80, the total inductance in the energy recovery operation is equal to L1z+L3z. Accordingly, the inductance of the second inductor L3y in the first energy recovery circuit 70 may be different from or equal to the inductance of the second inductor L3z in the second energy recovery circuit 80 to identify the driving performances of the energy recovery operations in the first and second energy recovery circuits 70 and 80.

As above, since the inductances of the two inductors of each of the first and second energy recovery circuits 70 and 80 are set in consideration of the self-inductance of the switching element of the scan driving IC 78, the driving performances of the first and second energy recovery circuits 70 and 80 are the same.

As described above, since the total inductance in the case of supplying the energy to the plasma display panel is less than the total inductance in the case of recovering the energy from the plasma display panel, the energy recovery efficiency increases while the strong discharge occurs.

Further, by identifying the driving performances of the energy recovery circuit connected to the scan electrode and the energy recovery circuit connected to the sustain electrode, the reliability of the energy recovery circuit increases.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures. Moreover, unless the term “means” is explicitly recited in a limitation of the claims, such limitation is not intended to be interpreted under 35 USC 112(6).

What is claimed is:

1. A plasma display apparatus comprising:
a plasma display panel including a scan electrode and a sustain electrode;
a first energy recovery circuit that forms a first energy supply path for supplying an energy to the scan electrode and a first energy recovery path for recovering an energy from the scan electrode; and
a second energy recovery circuit that forms a second energy supply path for supplying an energy to the sustain electrode and a second energy recovery path for recovering an energy from the sustain electrode,
wherein inductance of an inductor positioned on the first energy supply path is less than inductance of an inductor positioned in the first energy recovery path, and inductance of an inductor positioned on the second energy supply path is less than inductance of an inductor positioned on the second energy recovery path, and
a sum of inductances of a plurality of inductors included in the first energy recovery circuit is different from a sum of inductances of a plurality of inductors included in the second energy recovery circuit.

2. The plasma display apparatus of claim 1, wherein the sum of the inductances of the plurality of inductors included in the first energy recovery circuit is less than the sum of the inductances of the plurality of inductors included in the second energy recovery circuit.

3. The plasma display apparatus of claim 1, wherein the inductance of the inductor positioned on the first energy supply path is less than the inductance of the inductor positioned on the second energy supply path.

4. The plasma display apparatus of claim 1, wherein the inductance of the inductor positioned on the first energy recovery path is less than the inductance of the inductor positioned on the second energy recovery path.

5. The plasma display apparatus of claim 4, wherein the number of inductors positioned on the first energy recovery path is equal to one or more, and the number of inductors positioned on the second energy recovery path is equal to one or more.

6. The plasma display apparatus of claim 1, wherein time required to supply the energy to the scan electrode is shorter than time required to recover the energy from the scan electrode, and
time required to supply the energy to the sustain electrode is shorter than time required to recover the energy from the sustain electrode.

7. A plasma display apparatus comprising:
a plasma display panel including a scan electrode and a sustain electrode;
a first energy recovery circuit that forms a first energy supply path for supplying an energy to the scan electrode and a first energy recovery path for recovering an energy from the scan electrode, a first inductor being positioned on the first energy supply path, and a second inductor being positioned on the first energy recovery path; and
a second energy recovery circuit that forms a second energy supply path for supplying an energy to the sustain electrode and a second energy recovery path for recovering an energy from the sustain electrode, a third inductor being positioned on the second energy supply path, and a fourth inductor being positioned on the second energy recovery path,
wherein inductance of the first inductor is less than inductance of the second inductor, and inductance of the third inductor is less than inductance of the fourth inductor, and
a sum of the inductances of the first and second inductors is different from a sum of the inductances of the third and fourth inductors.

8. The plasma display apparatus of claim 7, wherein the sum of the inductances of the first and second inductors is less than the sum of the inductances of the third and fourth inductors.

9. The plasma display apparatus of claim 7, wherein the inductance of the first inductor is less than the inductance of the third inductor.

10. The plasma display apparatus of claim 7, wherein the inductance of the second inductor is less than the inductance of the fourth inductor.

11. The plasma display apparatus of claim 7, wherein the first energy recovery circuit includes
a first source capacitor charged to the energy recovered from the scan electrode,
a first energy supply controller connected between the first source capacitor and the first inductor, and
a first energy recovery controller connected between the first source capacitor and the second inductor.

12. The plasma display apparatus of claim 11, wherein the first energy supply path passes through the first source capacitor, the first energy supply controller, and the first inductor, and
the first energy recovery path passes through the second inductor, the first energy recovery controller, and the first source capacitor.

13. The plasma display apparatus of claim 7, wherein the second energy recovery circuit includes
a second source capacitor charged to the energy recovered from the sustain electrode,
a second energy supply controller connected between the second source capacitor and the third inductor, and
a second energy recovery controller connected between the second source capacitor and the fourth inductor.

14. The plasma display apparatus of claim 13, wherein the second energy supply path passes through the second source capacitor, the second energy supply controller, and the third inductor, and
the second energy recovery path passes through the fourth inductor, the second energy recovery controller, and the second source capacitor.

15. The plasma display apparatus of claim 7, wherein time required to supply the energy to the scan electrode is shorter than time required to recover the energy from the scan electrode, and
time required to supply the energy to the sustain electrode is shorter than time required to recover the energy from the sustain electrode.

16. A plasma display apparatus comprising:
a plasma display panel including a scan electrode and a sustain electrode;
a first energy recovery circuit that forms a first energy supply path for supplying an energy to the scan electrode and a first energy recovery path for recovering an energy from the scan electrode, a first inductor being positioned on the first energy supply path, and the first inductor and a second inductor being positioned on the first energy recovery path; and
a second energy recovery circuit that forms a second energy supply path for supplying an energy to the sustain electrode and a second energy recovery path for recovering an energy from the sustain electrode, a third inductor being positioned on the second energy supply path, and the third inductor and a fourth inductor being positioned on the second energy recovery path,
wherein a sum of inductances of the first and second inductors is different from a sum of inductances of the third and fourth inductors.

17. The plasma display apparatus of claim 16, wherein the sum of the inductances of the first and second inductors is less than the sum of the inductances of the third and fourth inductors.

18. The plasma display apparatus of claim 16, wherein the inductance of the first inductor is less than the inductance of the third inductor.

19. The plasma display apparatus of claim 16, wherein the inductance of the second inductor is less than the inductance of the fourth inductor.

20. The plasma display apparatus of claim 16, wherein the first energy recovery circuit includes
a first source capacitor charged to the energy recovered from the scan electrode,
a first energy supply controller connected between the first source capacitor and a common terminal of the first and second inductors, and
a first energy recovery controller connected between the first source capacitor and the second inductor.

21. The plasma display apparatus of claim 20, wherein the second energy recovery circuit includes
a second source capacitor charged to the energy recovered from the sustain electrode,
a second energy supply controller connected between the second source capacitor and a common terminal of the third and fourth inductors, and
a second energy recovery controller connected between the second source capacitor and the fourth inductor.

22. The plasma display apparatus of claim 21, wherein the first energy supply path passes through the first source capacitor, the first energy supply controller, and the first inductor,
the first energy recovery path passes through the first inductor, the second inductor, the first energy recovery controller, and the first source capacitor,
the second energy supply path passes through the second source capacitor, the second energy supply controller, and the third inductor, and
the second energy recovery path passes through the third inductor, the fourth inductor, the second energy recovery controller, and the second source capacitor.

23. The plasma display apparatus of claim 16, wherein time required to supply the energy to the scan electrode is shorter than time required to recover the energy from the scan electrode, and
time required to supply the energy to the sustain electrode is shorter than time required to recover the energy from the sustain electrode.
